(19) United States
(12) Patent Application Publication
(10) Pub. No.: US 2010/0251577 A1
(43) Pub. Date: Oct. 7, 2010

(54) THERMOPLASTIC RESIN FOR FOAM MOLDING, THERMOPLASTIC RESIN COMPOSITION FOR FOAM MOLDING, FOAM MOLDED ARTICLE AND FOOTWEAR

(75) Inventor: Katsuhiro Yamada, Chiba-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 12/739,994

(22) PCT Filed: Oct. 28, 2008
(86) PCT No.: PCT/JP2008/069990

§ 371 Date: Apr. 27, 2010

(30) Foreign Application Priority Data
Oct. 31, 2007 (JP) 2007-283064

(51) Int. Cl. A43B 13/14; B32B 3/26; C08L 23/06; A43B 13/38

(52) U.S. Cl. 36/25 R; 428/304.4; 524/585; 521/143; 36/43

(57) ABSTRACT

A thermoplastic resin for foam molding wherein the number of fish eyes (FE) having a maximum length of 0.5 mm or more is 50/m² or more when made into a film having a thickness of 30 μm, and a thermoplastic resin composition for foam molding containing the above-described resin and a foaming agent.

### TECHNICAL FIELD

The present invention relates to a thermoplastic resin for foam molding, a thermoplastic resin composition for foam molding, a foam molded article and footwear.

### BACKGROUND ART

Foam molded articles are used as miscellaneous daily goods, floor materials, sound insulation materials, heat insulation materials, members for footwear (outer sole (lower bottom), midsole (upper bottom), insole (sockliner), etc.) and the like. As the foam molded article, there are known those obtained by foam molding of thermoplastic resins, for example, a foam molded article obtained by foam molding in a metal mold of a resin composition prepared by compounding an inorganic filler, chemical foaming agent, crosslinking agent and the like into a polyethylene resin such as an ethylene-vinyl acetate copolymer, ethylene-α-olefin copolymer or the like (see, e.g., JP-B No. 3-2657, JP-A No. 2005-314638), a foam molded article obtained by extrusion foam molding of a resin composition prepared by compounding an inorganic filler and a physical foaming agent into an ethylene-α-olefin copolymer (see, e.g., JP-A No. 10-182866); and the like.

Thermoplastic resins as described above are used widely as a film and the like, in addition to applications such as the above-described foam molded articles and the like, and the consumption amount as such a film application is very large. In the film application, appearance thereof is valued significantly, and it is required that the amount of extraneous materials in the film is as small as possible. Extraneous materials found occasionally in the film are called fish eyes (hereinafter, FE), and the content thereof includes extraneous materials such as fibers, dust and the like, and various materials such as degraded substances, oxidation crosslinked polymers and the like. As thermoplastic resins suitable for the film application, polyethylene resins containing few FE have been investigated until now (see, e.g., JP-A No. 2004-291489, JP-A No. 2004-002763, JP-A No. 2004-099875, JP-A No. 2003-026814).

In the case of industrial production of a thermoplastic resin, however, it is difficult in many cases to continuously ensure an article containing few FE stably even if the above-exemplified investigations for obtaining a thermoplastic resin containing few FE are adopted. For example, in the case of generation of a trouble in the process for producing a thermoplastic resin, the polymerization is once stopped and started again in some cases. Further, difficult resins are produced in some cases in the same apparatus. As described above, production sometimes becomes unstable in start up and in change of resins.

When a film is produced using a thermoplastic resin produced under such unstable conditions, the resultant film contains a lot of FE in some cases. Such a film cannot be used as a packaging material or the like, and according to circumstances, disposal thereof is compelled, leading to significantly large economical loss. Also from the standpoint of environmental protection, it is a cause for wastage of finite energy.

### DISCLOSURE OF THE INVENTION

Under such conditions, the present inventors have intensively investigated and found that a thermoplastic resin which, when molded into a film, contains a lot of FE and cannot be used as a film can be used for foam molding.

That is, in the first aspect, the present invention relates to a thermoplastic resin for foam molding wherein the number of fish eyes (FE) having a maximum length of 0.5 mm or more is 50/m² or more when made into a film having a thickness of 30 μm.

In the second aspect, the present invention relates to a thermoplastic resin composition for foam molding, comprising the above-described thermoplastic resin for foam molding, and a foaming agent.

In the third aspect, the present invention relates to a foam molded article obtained by foaming of the above-described thermoplastic resin composition for foam molding.

In the fourth aspect, the present invention relates to a member for footwear, having the above-described foam molded article.

In the fifth aspect, the present invention relates to footwear having the above-described member for footwear.

### EMBODIMENTS FOR CARRYING OUT THE INVENTION

As the thermoplastic resin in the present invention, there are exemplified a polyethylene resin, polypropylene resin, polyvinyl chloride, polyvinylidene chloride, polystyrene, styrene-acrylonitrile copolymer, nylon, styrene-butadiene rubber, natural rubber and the like. These thermoplastic resins are used singly or in combination of two or more.

As the thermoplastic resin in the present invention, polyolefin resins are preferable such as a polyethylene resin, polypropylene resin and the like.

The polyolefin resin is a polymer containing olefin-based monomer units in an amount of 50 wt % or more (here, the amount of the polymer is 100 wt %). The olefin includes ethylene, propylene, 1-butene, 1-pentene, 1-hexene, 1-heptene, 1-octene and the like, and these are used singly or in combination of two or more, and preferable are olefins having a carbon number of 2 or more and 20 or less.

As the polyolefin resin, a polyethylene resin which is a polymer containing ethylene-based monomer units in an amount of 50 wt % or more (here, the amount of the polymer is 100 wt %) is particularly preferable from the standpoint of foaming stability. As the polyethylene resin, an ethylene-α-olefin copolymer, ethylene-unsaturated ester copolymer, high pressure polymerized low density polyethylene and the like an be used, and these are used singly or in combination of two or more. Particularly when the foam molded article of the present invention is used as a shoe sole member such as a midsole and the like, it is preferable to use an ethylene-α-olefin copolymer and an ethylene-unsaturated ester copolymer in combination from the standpoint of allowing the midsole to have sufficient strength and enhancing adhesion with other shoe sole member such as an upper sole and the like. The preferable compounding ratio of ethylene-α-olefin copolymer/ethylene-unsaturated ester copolymer is 99/1 to 30/70 (weight ratio).

The density of the polyethylene resin is usually 850 kg/m³ or more and 960 kg/m³ or less. From the standpoint of enhancing the lightness of a foam molded article, the density is preferably 940 kg/m³ or less, more preferably 930 kg/m³ or less, and further preferably 925 kg/m³ or less. The density is measured by an underwater substitution method described in JIS K7112-1980 after carrying out annealing described in JIS K6760-1995.

The melt flow rate (MFR) of the polyethylene resin is usually 0.01 g/10 min or more and 20 g/10 min or less. The MFR is preferably 0.05 g/10 min or more, more preferably 0.1 g/10 min or more from the standpoint of enhancing foaming magnification ratio to enhance the lightness of a foam molded article. From the standpoint of enhancing the strength of a foam molded article and imparting an excellent foaming property, it is preferably 10 g/10 min or less, more preferably 8 g/10 min or less. The MFR is measured by a method A under conditions of a temperature of 190° C. and a load of 21.18 N according to JIS K7210-1995.

The ethylene-α-olefin copolymer includes polymers having a monomer unit based on ethylene and a monomer unit based on an α-olefin having carbon atom number of 3 or more and 20 or less. Examples of the monomer unit include propylene, 1-butene, 1-pentene, 1-hexene, 1-heptene, 1-octene, 1-nonene, 1-decene, 1-dodecene, 4-methyl-1-pentene, 4-methyl-1-hexene and the like. The above-described monomers may be used singly or in combination of two or more.

Examples of the ethylene-α-olefin copolymer include an ethylene-propylene copolymer, ethylene-1-butene copolymer, ethylene-1-hexene copolymer, ethylene-1-octene copolymer and the like, preferably an ethylene-1-butene copolymer, ethylene-1-hexene copolymer, ethylene-1-butene-1-hexene copolymer and ethylene-1-butene-1-octene copolymer.

The ethylene-α-olefin copolymer is produced by known polymerization methods using known catalysts for olefin polymerization. Examples thereof include a slurry polymerization method, solution polymerization method, bulk polymerization method, gas phase polymerization method and the like using a Ziegler-Natta catalyst, or complex catalysts such as metallocene complexes, non-metallocene complexes and the like.

As the ethylene-α-olefin copolymer, particularly suitable are an ethylene copolymer for pressurized foam molding having a monomer unit based on ethylene and a monomer unit based on an α-olefin having a carbon atom number of 3 to 20 in which the molecular weight distribution (Mw/Mn) is 5 or more and the flow activation energy (Ea) is 40 kJ/mol or more disclosed in JP-A No. 2005-314638, an ethylene copolymer for pressurized foam molding having a monomer unit based on ethylene and a monomer unit based on an α-olefin having a carbon atom number of 3 to 20 in which the melt flow rate is 0.05 to 0.8 g/10 min and the flow activation energy is 40 kJ/mol or more disclosed in JP-A No. 2005-314641; and the like, from the standpoint of foaming property and the like.

The ethylene-unsaturated ester copolymer is a polymer having a monomer unit based on ethylene and a monomer unit based on an unsaturated ester. The unsaturated ester includes vinyl carboxylates such as vinyl acetate, vinyl propionate and the like; unsaturated alkyl carboxylates such as methyl acrylate, ethyl acrylate, n-propyl acrylate, isopropyl acrylate, n-butyl acrylate, t-butyl acrylate, isobutyl acrylate, methyl methacrylate, ethyl methacrylate, n-propyl methacrylate, isopropyl methacrylate, n-butyl methacrylate, t-butyl methacrylate, isobutyl methacrylate and the like. The above-described monomers may be used singly or in combination of two or more.

The ethylene-unsaturated ester copolymer includes copolymers having a monomer unit based on ethylene and a monomer unit based on at least one unsaturated ester selected from vinyl carboxylates and unsaturated alkyl carboxylates such as an ethylene-vinyl acetate copolymer, ethylene-methyl acrylate copolymer, ethylene-ethyl acrylate copolymer, ethylene-methyl acrylate-ethyl acrylate copolymer, ethylene-methyl methacrylate copolymer, ethylene-ethyl methacrylate copolymer and the like, preferably, an ethylene-vinyl acetate copolymer, ethylene-methyl acrylate copolymer, ethylene-ethyl acrylate copolymer and ethylene-methyl methacrylate copolymer.

The method of producing the ethylene-unsaturated ester copolymer is not particularly restricted, and there is mentioned, for example, a method in which ethylene and an unsaturated ester are copolymerized using a tank polymerization reactor or tube polymerization reactor, in the presence of a radical generator under polymerization conditions of a polymerization pressure of 1000 kg/cm² or more and 4000 kg/cm² or less and a polymerization temperature of 200° C. or more and 300° C. or less.

The high pressure polymerized low density polyethylene is a polymer obtained by polymerization of ethylene using a tank polymerization reactor or tube polymerization reactor, in the presence of a radical generator under polymerization conditions of a polymerization pressure of 1000 kg/cm² or more and 4000 kg/cm² or less and a polymerization temperature of 200° C. or more and 300° C. or less.

The thermoplastic resin for foam molding of the present invention is a resin wherein the number of fish eyes (FE) having a maximum length of 0.5 mm or more contained in the film is 50/m² or more when formed into a film having a thickness of 30 μm. It is preferable that the number of the fish eyes (FE) is 1000/m² or less.

The above-described film for FE measurement is formed by extrusion molding. In forming the film for FE measurement, known film processing machines such as an inflation processing machine, T die cast processing machine and the like can be used, and when the thermoplastic resin is a polyethylene resin, it is particularly preferable to perform film formation using an inflation processing machine. As the method for measuring the FE number in these thermoplastic resins, there are mentioned a method in which a film having a thickness of 30 μm is formed using various processing machines, and the number is measured in line during film formation by a laser mode FE counter, a method in which the number is measured in line or off line by a CCD camera, and the like. The method in which the number is measured in line during film formation by a laser mode FE counter is particularly preferable.

As the method for measuring in line during film formation using a laser mode FE counter, when the thermoplastic resin is, for example, a polyethylene resin, there is mentioned a method in which an inflation film having a thickness of 30 μm is produced under the following molding conditions, and the FE number is measured by a laser counter in formation of the film.

Extruder: single screw extruder manufactured by Tanabe Plastics Machinery Co. Ltd.
Screw diameter: 40 mmφ
Screw revolution: 80 rpm
Discharge rate: 20 kg/h
Die diameter: 125 mmφ
Lip width: 2.0 mm
Laser mode FE counter: LAZER EYE-1000 (manufactured by Yaskawa Electric Corporation)
Film check width: 300 mm

The processing temperature in forming the above-described film for FE measurement is usually 190° C. when the thermoplastic resin is a polyethylene resin, and usually 250° C. when the thermoplastic resin is a polypropylene resin. When the thermoplastic resin is amorphous, processing is carried out usually at a glass transition temperature.

In forming the above-described film for FE measurement, it is desirable to add a stabilizer such as an antioxidant in an amount of about 1000 to 2000 ppm or the like, for preventing increase of FE due to thermal degradation in film formation processing.

The maximum length of FE means a longer one of observed longitudinal and transversal lengths of FE. The thermoplastic resin for foam molding of the present invention is a resin wherein the number of fish eyes (FE) having a maximum length of 0.5 mm or more is 50/m² or more when made into a film having a thickness of 30 μm. The present invention is based on a finding that a resin having a lot of FE which cannot be used conventionally for a film is suitable for foam molding. Though the reason for suitability of such a resin having a lot of FE for foam molding is not clear, it is hypothesized that these FE act as a kind of foam nucleating agent in foaming.

Though the reasons for these FE observed in the formed film are various, FE are generated due to insufficient melt mixing with the base resin, and believed to occur by mixing of a component having different viscosity (molecular weight) from the base resin, a gel component, oxidation degraded resin, extraneous resin, packaging material fragments (paper, thread, fiber and the like), dust and the like during any of a raw material resin production process, bagging and transportation process, and film molding process.

The reason for production of a thermoplastic resin having a lot of FE includes the following matters.

(1) A case of large variation exerted in the production process, particularly in a polymerization process system. Specifically, a case of performing change between articles which are different significantly in polymerization conditions, MFR, density and the like, in producing resins using the same apparatus; and the like.

(2) A case of contamination of different catalysts and the like in the polymerization process and the like.

(3) In start up after termination of the polymerization.

(4) In start up of a granulator.

(5) A case of mixing of extraneous materials such as dust in air, fibers, different resins and the like in a free running process, post treatment process, packaging process and the like after the polymerization process.

The thermoplastic resin for foam molding of the present invention preferably has a gel fraction of 0.04 wt % or less. When the content of a gel component as an insoluble component in the resin is too large, there occurs in some cases insufficient appearance of the foam molded article such as a tendency of emergence of extraneous materials in the resultant foam molded article, and the like. The gel fraction can be evaluated by weighing 1.0 g of the thermoplastic resin in a basket made of #400 wire net, subjecting this to Soxhlet extraction for 24 hours in 110 ml of xylene, and after extraction, measuring the weight of the components remaining on the wire net.

The above-described thermoplastic resin for foam molding, and the thermoplastic resin composition for foam molding of the present invention containing a foaming agent are used suitably for production of a foam molded article. As the method for producing a foam molded article using the thermoplastic resin composition for foam molding, there is mentioned a method in which a thermoplastic resin for foam molding and a foaming agent are mixed, and heated or pressure-reduced, to gasify the foaming agent or to generate a decomposed gas, thereby producing a molded article containing bubbles.

The foaming agent includes physical foaming agents and chemical foaming agents.

Examples of the physical foaming agent include foaming agents based on an inorganic gas such as air, nitrogen, water, carbon dioxide gas and the like, and volatile foaming agents such as butane, freon, pentane, hexane and the like.

The compounding ratio of the physical foaming agent is usually 5 parts by weight or more with respect to 100 parts by weight of thermoplastic resin for foam molding. From the standpoint of enhancing the foaming magnification ratio of a foam molded article, it is preferably 10 parts by weight or more. The compounding ratio of the physical foaming agent is usually 60 parts by weight or less with respect to 100 parts by weight of thermoplastic resin for foam molding. From the standpoint of enhancing the strength of a foam molded article, it is preferably 50 parts by weight or less.

Examples of the chemical foaming agent include thermal decomposition type foaming agents such as azodicarbonamide, barium azodicarboxylate, azobisbutyronitrile, nitrodiguanidine, N,N-dinitrosopentamethylenetetramine, N,N′-dimethyl-N,N′-dinitrosoterephthalamide, P-toluenesulfonyl hydrazide, P,P′-oxybis(benzenesulfonyl hydrazide)azobisisobutyronitrile, P,P′-oxybisbenzenesulfonyl semicarbazide, 5-phenyl tetrazole, trihydrazino triazine, hydrazodicarbonamide and the like, and these are used singly or in combination of two or more. Of them, azodicarbonamide or sodium hydrogen carbonate is preferable.

The compounding ratio of the chemical foaming agent is usually 1 part by weight or more with respect to 100 parts by weight of thermoplastic resin for foam molding. From the standpoint of enhancing the foaming magnification ratio of a foam molded article, it is preferably 1.5 parts by weight or more. The compounding ratio of the chemical foaming agent is usually 50 parts by weight or less with respect to 100 parts by weight of thermoplastic resin for foam molding. From the standpoint of enhancing the strength of a foam molded article, it is preferably 15 parts by weight or less, further preferably 10 parts by weight or less.

The above-described physical foaming agent and chemical foaming agent may be used together.

In the thermoplastic resin for foam molding of the present invention, a foaming auxiliary agent may be compounded, if necessary. The foaming auxiliary agent includes a compound consisting of urea as the main component; zinc oxide, lead oxide and the like. The use amount of the foaming auxiliary agent is preferably 0.1 wt % or more, more preferably 1 wt % or more with respect to 100 wt % of the sum of the foaming agent and the foaming auxiliary agent. The use amount of the foaming auxiliary agent is preferably 30 wt % or less, more preferably 20 wt % or less, further preferably 10 wt % or less, and particularly preferably 5 wt % or less with respect to 100 wt % of the sum of the foaming agent and the foaming auxiliary agent.

The thermoplastic resin composition for foam molding of the present invention may further contain a crosslinking agent in addition to the foaming agent. When the thermoplastic resin for foam molding contains a crosslinking agent, it is preferable to contain a chemical foaming agent as the foaming agent. A cross-linked foam molded article can be obtained by foaming of a thermoplastic resin composition for foam molding containing a thermoplastic resin for foam molding, chemical foaming agent and crosslinking agent. Particularly when the foam molded article of the present invention is used as a shoe sole member such as a midsole and the like, the foam molded article is preferably made into a cross-linked foam molded article for obtaining sufficient strength.

As the crosslinking agent, organic peroxides having a decomposition temperature which is not lower than the flow initiation temperature of the thermoplastic resin for foam molding to be used are suitably used, and examples thereof include dicumyl peroxide, 1,1-ditertiary butyl peroxy-3,3,5-trimethylcyclohexane, 2,5-dimethyl-2,5-ditertiary butyl peroxy hexane, 2,5-dimethyl-2,5-ditertiary butyl peroxy hexine, α,α-ditertiary butyl peroxy isopropyl benzene, tertiary butyl peroxy ketone, tertiary butyl peroxy benzoate and the like.

In the thermoplastic resin for foam molding or the thermoplastic resin composition for foam molding of the present invention, if necessary, fillers, crosslink auxiliary agents, heat resistant stabilizers, weather resistant agents, lubricants, antistatic agents, pigments and the like may be compounded. The fillers include metal oxides such as titanium oxide, calcium oxide, magnesium oxide, silicon oxide and the like; carbonates such as magnesium carbonate, calcium carbonate and the like. The lubricants include higher fatty acids such as salicylic acid, stearic acid and the like; metal compounds of the higher fatty acids; and the like.

A thermoplastic resin composition for foam molding can be obtained by melt-mixing the chemical foaming agent and thermoplastic resin for foam molding as described above, and if necessary, various additives, at a temperature under which the above-described chemical foaming agent is not decomposed. As the method for melt-mixing the above-described resin and chemical foaming agent, there is mentioned a method of mixing using a general mixing machine such as a granulator, banbury mixer, henschel mixer and the like. Melt-mixing is carried out at a temperature under which the chemical foaming agent is not decomposed, and this temperature is usually 150° C. or less, preferably 140° C. or less, more preferably 135° C. or less.

A thermoplastic resin composition for foam molding can be obtained by melt-mixing the crosslinking agent, chemical foaming agent and thermoplastic resin for foam molding as described above, and if necessary various additives, at a temperature under which the above-described crosslinking agent and chemical foaming agent are not decomposed. As the method for melt-mixing the above-described resin, chemical foaming agent and crosslinking agent, there is mentioned a method of mixing using a general mixing machine such as a granulator, banbury mixer, henschel mixer and the like. The temperature under which the crosslinking agent is not decomposed means a temperature which is not higher than the 1 minute half life temperature of the crosslinking agent. Usually, the 1 minute half life temperature of the crosslinking agent is described in MSDS of the crosslinking agent, and the like.

The foam molded article of the present invention is obtained by foam molding of the above-described thermoplastic resin composition for foam molding.

The method for producing the foam molded article of the present invention includes an extrusion foaming method, normal pressure foam molding method, pressurized foam molding method and the like.

Examples of the extrusion foaming method include a method in which the thermoplastic resin for foam molding of the present invention, or a thermoplastic resin composition for foam molding containing the thermoplastic resin for foam molding and a chemical foaming agent is put into a hopper of an extruder, and extruded at a temperature around the melting point of the resin, and in this extrusion, a physical foaming agent is pressed into through a pressing hole disposed on the way of the extruder, and the resin is extruded from a mouth piece of desired shape, to obtain a foam molded article, a method in which a thermoplastic resin composition for foam molding containing the thermoplastic resin for foam molding and a chemical foaming agent is put into a hopper of an extruder, and extruder from a mouth piece of given shape, to obtain a foam molded article; and other methods.

Examples of the normal pressure foam molding method include a method in which the thermoplastic resin for foam molding of the present invention and a chemical foaming agent are melt-mixed by a mixing roll, kneader, extruder and the like at a temperature under which the above-described chemical foaming agent is not decomposed to obtain a thermoplastic resin composition for foam molding which is then filled into a metal mold by an injection molding machine and the like, foamed under normal pressure with heating, then, cooled to obtain a foam molded article to be taken out, a method in which the thermoplastic resin composition for foam molding is put into a metal mold, formed under normal pressure with heating, then, cooled to obtain a foam molded article to be taken out; and other methods.

Examples of the pressurized foam molding method include a method in which the thermoplastic resin for foam molding and a chemical foaming agent are melt-mixed by a mixing roll, kneader, extruder and the like at a temperature under which the above-described chemical foaming agent is not decomposed to obtain a thermoplastic resin composition for foam molding which is then filled into a metal mold by an injection molding machine and the like, foamed under pressurized (pressure keeping) and heated conditions, then, cooled to obtain a foam molded article to be taken out, a method in which the thermoplastic resin composition for foam molding in the form of sheet obtained by melt-mixing is placed in a metal mold, foamed under pressurized (pressure keeping) and heated conditions by a pressing machine and the like, then, cooled to obtain a foam molded article to be taken out; and other methods.

In the present invention, the foam molded article obtained by the above-described method may be formed into a given shape by compression molding. The compression molding conditions include generally a temperature of 120 to 180° C., a pressing pressure of 30 to 300 kg/cm², a compression time of 2 to 50 minutes and a compression ratio of about 1.1 to 3.5.

When the foam molded article is used as a shoe sole member such as a midsole and the like, it is preferable to use a crosslinked foam molded article obtained by pressurized foam molding of a thermoplastic resin composition for foam molding containing a thermoplastic resin for foam molding, chemical foaming agent and crosslinking agent, since strength and heat resistance are required.

That is, there are mentioned a method in which the thermoplastic resin for foam molding, a crosslinking agent and a chemical foaming agent are melt-mixed at a temperature under which the above-described crosslinking agent and the above-described foaming agent are not decomposed to obtain a thermoplastic resin composition for foam molding which is then filled into a metal mold, foamed under pressurized (pressure keeping) and heated conditions, then, cooled to obtain a foam molded article to be taken out, a method in which the thermoplastic resin composition for foam molding in the form of sheet obtained by melt-mixing is placed in a metal mold, foamed under pressurized (pressure keeping) and heated conditions by a pressing machine and the like, then, cooled to obtain a foam molded article to be taken out; and other methods.

The foam molded article of the present invention may be laminated with other materials to give a multi-layered foam molded article. The other materials include vinyl chloride resin materials, styrene copolymer rubber materials, olefin copolymer rubber materials (ethylene copolymer rubber materials, propylene copolymer rubber materials and the like), natural leather materials, artificial leather materials, cloth materials and the like, and at least one of these materials is used.

As the method of producing the multi-layered foam molded article, there is mentioned, for example, a method in which the foam molded article of the present invention and a molded article made of other material which has been separately molded are pasted by thermal pasting, or with a chemical adhesive and the like; or other method. As the chemical adhesive, known adhesives can be used. Of them, in particular, urethane chemical adhesives, chloroprene chemical adhesive and the like are preferable. It may also be permissible to previously apply an overcoat agent called primer, in pasting with the chemical adhesives.

The foam molded article of the present invention can be suitably used, in the form of single layer or multi-layer, as a footwear member such as a midsole, outer sole, insole and the like, and the footwear having such a member includes shoes, sandals and the like. The foam molded article of the present invention is also used as a building material such as a heat insulator, cushioning material and the like, in addition to shoe members.

The present invention will be illustrated further in detail by examples and comparative examples below.

(1) Melt Flow Rate (MFR, Unit: g/10 min)

The melt flow rate was measured by a method A under conditions of a temperature of 190° C. and a load of 21.18 N according to JIS K7210-1995.

(2) Density (Unit: kg/m²)

The density was measured by an underwater substitution method described in JIS K7112-1980 after carrying out annealing described in JIS K6760-1995.

### (3) Method of Measuring FE Number

### (3-1) Film Molding

BHT as an antioxidant was compounded in a concentration of 2000 ppm into a thermoplastic resin, and the resin was subjected to an inflation film molding method under the following molding conditions to produce a film having a thickness of 30 μm.

Extruder (manufactured by Tanabe Plastics Machinery Co. Ltd.,): single screw 40 mmφ, screw revolution: 80 rpm, powder treatment amount: 20 kg/h, die diameter: 125 mmφ, lip width: 2.0 mm, processing temperature: 190° C.
(3-2) Measurement of FE Number (Unit: number/m²)

In the above-described film formation, the number of fish eyes per 1 m² of film was measured at a film check width of 300 mm and a film thickness of 30 μm using (dousuisyutsuki) transmitted light receiving mode fish eye counter LAZER EYE-1000 (manufactured by Yaskawa Electric Corporation). Of them, those having a maximum length of 0.5 mm or more was counted, to obtain the number of FE.

### (4) Gel Fraction in Thermoplastic Resin (Unit: wt %)

A thermoplastic resin (1.0 g) was weighed in a basket made of #400 wire net, subjected to Soxhlet extraction for 24 hours in 110 ml of xylene, and after extraction, the weight of the components remaining on the wire net was measured, and the gel fraction was calculated according to the following formula.

<gel fraction>[wt %]=<the amount of components remaining on wire net>[g]/1.0 [g]×100

### (5) Specific Gravity of Foam Molded Article (Unit: None)

The specific gravity was measured according to ASTM-D297.

(6) Tensile Strength at Break of Foam Molded Article (Unit: kg/cm)

The tensile strength at break of a foam molded article was measured according to ASTM-D642. Specifically, a foam molded article was sliced into a thickness of 2 mm, then, punched into a shape of No. 3 dumbbell, fabricating a test piece. The test piece was pulled at a rate of 500 mm/min, and the maximum load F (kg) when the test piece was broken was divided by the thickness of the sample piece, to obtain tensile strength at break.

### (7) Elongation at Break of Foam Molded Article (Unit: %)

The elongation at break of a foam molded article was measured according to ASTM-D642.

### (8) Hardness of Sliced Surface of Foam Molded Article (Unit: None)

A layer from the surface (metal mold-contacted surface) to a depth of 1.5 mm of the resultant foam molded article was removed, using a slicer for food (manufactured by Nantsune Co., Ltd., food slicer HBC-2S type). The hardness of the sliced surface was measured by a method C hardness tester according to ASTM-D2240.

(10) Number of Pinholes in Foam Molded Article (Unit: number/m²)

The resultant foam molded article was cut into a 8 cm×8 cm square (0.08 m×0.08 m square), then, sliced into a sheet having a thickness of 1.5 mm using the above-described slicer for food. For measurement, parts corresponding to the surface layer of the foam molded article before slicing were not used, and parts corresponding to the inside of the foam molded article were only used. Fifteen pieces of the resultant sliced foamed articles were visually observed, and a defect through which the other side of the sliced foamed article was visible even a little was regarded as a pinhole, and the number thereof was measured, and the number of pinholes per unit area was calculated according to the following formula.

<Pinhole number per unit area (number/m²)>=<whole count (number) of pinholes found by visual observation of 15 pieces>/<0.08 m×0.08 m>×15

### Example 1

For an ethylene-α-olefin copolymer obtained in start up after termination of polymerization ([MFR=0.5 g/10 min, density=912 kg/m³]; hereinafter, described as PE (1)), the number of FE of 0.5 mm or more was measured to find a number of 170/m². 100 parts by weight of PE (1), 10 parts by weight of heavy calcium carbonate, 0.5 parts by weight of stearic acid, 1.5 parts by weight of zinc oxide, 3.5 parts by weight of chemical foaming agent (manufactured by Sankyo Chemical Co., Ltd., CELLMIC CE) and 0.7 parts by weight of dicumyl peroxide (1 hour half period temperature: 132° C., 1 minute half period temperature: 182° C.) were mixed using a roll mixer at conditions of a roll temperature of 120° C. and a mixing time of 5 minutes, to obtain a resin composition. The resin was filled in a 15 cm×15 cm×1.0 cm metal mold and pressure-foamed under conditions of a temperature of 160° C., a time of 15 minutes and a pressure of 150 kg/cm², to obtain a foam molded article. The results of evaluation of physical properties of the resultant foam molded article are shown in Table 1.

### Example 2

For an ethylene-α-olefin copolymer obtained in start up after termination of polymerization ([MFR=0.5 g/10 min, density=912 kg/m³]; hereinafter, described as PE (2)), the number of FE of 0.5 mm or more was measured to find a number of 103/m². A foam molded article was obtained in the same manner as in Example 1 excepting that PE (1) was changed to PE (2). The results of evaluation of physical properties of the resultant foam molded article are shown in Table 1.

### Example 3

For an ethylene-α-olefin copolymer obtained in start up after termination of polymerization ([MFR=0.5 g/10 min, density=912 kg/m³]; hereinafter, described as PE (3)), the number of FE of 0.5 mm or more was measured to find a number of 70/m². A foam molded article was obtained in the same manner as in Example 1 excepting that PE (1) was changed to PE (3). The results of evaluation of physical properties of the resultant foam molded article are shown in Table 1.

### Comparative Example 1

For an ethylene-α-olefin copolymer ([MFR=0.5 g/10 min, density=912 kg/m³]; hereinafter, described as PE (4)), the number of FE of 0.5 mm or more was measured to find a number of 36/m². A foam molded article was obtained in the same manner as in Example 1 excepting that PE (1) was changed to PE (4). The results of evaluation of physical properties of the resultant foam molded article are shown in Table 2.

### Comparative Example 2

For an ethylene-α-olefin copolymer ([MFR=0.5 g/10 min, density=912 kg/m³]; hereinafter, described as PE (5)), the number of FE of 0.5 mm or more was measured to find a number of 3/m². A foam molded article was obtained in the same manner as in Example 1 excepting that PE (1) was changed to PE (5). The results of evaluation of physical properties of the resultant foam molded article are shown in Table 2.

TABLE 1

| | | Example 1 | Example 2 | Example 3 |
|---|---|---|---|---|
| Thermoplastic resin | | PE (1) | PE (2) | PE (3) |
| Gel fraction in | [wt %] | 0 | 0 | 0 |
| thermoplastic resin | | (no | (no | (no |
| | | insoluble | insoluble | insoluble |
| | | part) | part) | part) |
| Number of FE of | [number/m²] | 170 | 103 | 70 |
| 0.5 mm or more in | | | | |
| thermoplastic resin | | | | |
| Physical properties of foam | | | | |
| molded article | | | | |
| Specific gravity | [—] | 104 | 109 | 103 |
| Hardness of foamed | [—] | 45 | 45 | 45 |
| article sliced surface | | | | |
| Number of pinholes | [number/m²] | 52 | 104 | 219 |
| in foamed article | | | | |
| Tensile strength at | [kg/cm] | 10 | 10 | 10 |
| break | | | | |
| Elongation at break | [%] | 267 | 250 | 256 |

TABLE 2

| | | Comparative | Comparative |
|---|---|---|---|
| | | Example 1 | Example 2 |
| Thermoplastic resin | | PE (4) | PE (5) |
| Gel fraction in | [wt %] | 0 | 0 |
| thermoplastic resin | | (no insoluble | (no insoluble |
| | | part) | part) |
| Number of FE of 0.5 mm | [number/m²] | 36 | 3 |
| or more in | | | |
| thermoplastic resin | | | |
| Physical properties of foam molded | | | |
| article | | | |
| Specific gravity | [—] | 104 | 105 |
| Hardness of foamed | [—] | 45 | 45 |
| article sliced surface | | | |
| Number of pinholes in | [number/m²] | 354 | 375 |
| foamed article | | | |
| Tensile strength at | [kg/cm] | 10 | 10 |
| break | | | |
| Elongation at break | [%] | 256 | 272 |

### INDUSTRIAL APPLICABILITY

The present invention is based on a finding that a thermoplastic resin which cannot be used for a film and conventionally subjected to a disposal treatment can be used for foam molding, and its economical effect is significantly large.

1. A thermoplastic resin for foam molding wherein the number of fish eyes (FE) having a maximum length of 0.5 mm or more is 50/m² or more when made into a film having a thickness of 30 μm.

2. The thermoplastic resin for foam molding according to claim 1 which has a gel fraction of 0.04 wt % or less.

3. The thermoplastic resin for foam molding according to claim 1, wherein the thermoplastic resin is a polyethylene resin.

4. A thermoplastic resin composition for foam molding comprising the thermoplastic resin for foam molding described in claim 1, and a foaming agent.

5. The thermoplastic resin composition for foam molding according to claim 4, wherein the foaming agent is a chemical foaming agent.

6. The thermoplastic resin composition for foam molding according to claim 5 further comprising a crosslinking agent.

7. A foam molded article obtained by foaming of the thermoplastic resin composition for foam molding described in claim 4.

8. The foam molded article according to claim 7 obtained by compression molding.

9. A member for footwear, the member having the foam molded article described in claim 7.

10. Footwear having the member for footwear described in claim 9.

11. A method of producing the thermoplastic resin composition for foam molding described in claim 6, the method comprising melt-mixing a thermoplastic resin for foam molding, the thermoplastic resin being a thermoplastic resin wherein the number of fish eyes (FE) having a maximum length of 0.5 mm or more is 50/m² or more when made into a film having a thickness of 30 μm, a crosslinking agent and a chemical foaming agent at a temperature at which the crosslinking agent and the chemical foaming agent are not decomposed.
